(19) United States
(12) Patent Application Publication
(10) Pub. No.: US 2025/0231664 A1
(43) Pub. Date: Jul. 17, 2025

(54) DYNAMIC CONTENT GRID

(71) Applicant: Daniel Varro, Waterloo (CA)

(72) Inventor: Daniel Varro, Waterloo (CA)

(73) Assignee: Vibe Driven Inc., Mississauga (CA)

(21) Appl. No.: 19/017,539

(22) Filed: Jan. 11, 2025

Related U.S. Application Data
(60) Provisional application No. 63/620,576, filed on Jan. 12, 2024.

(51) Int. Cl. G06F 3/0482; G06F 3/0484; G06F 3/14

(52) U.S. Cl. CPC G06F 3/0482; G06F 3/0484; G06F 3/14; G06F 2203/04803

(57) ABSTRACT

A computer program product, method and system are provided for optimizing a viewport on a consumer electronic device. A content grid is displayed on a viewport of the consumer electronic device. The content grid includes an array of media elements displayed in a global feed and algorithmically arranged with little cost of user interaction through an expanding function. In response to a user selecting a first media element of the array of media elements, the size of the selected first media element is expanded, and the displayed content grid is reconfigured to accommodate the expanded first media element. In response to new media content being uploaded to the consumer electronic device, a new media element corresponding to the uploaded new media content is fitted to the displayed content grid based on results of a bin packing algorithm.

### FIELD OF THE INVENTION

The present embodiments described in this specification relate generally to an application or tool allowing for viewing and interacting with streams of content on a computing device viewport.

### BACKGROUND OF THE INVENTION

Current solutions for displaying and serving content to users are predicated on notions from the early mobile web. Specifically, early notions were that mobile viewports would decrease in size as mobile phones decreased in size and that mobile computing power would never rival the computing power of a personal computer such as a desktop or laptop computer.

Social media applications for viewing and interacting with content on mobile viewports generally rely on a list view or static grid view to display content. In such cases, a balance is struck between navigating content from a general view to focusing on a user-selected view in order to optimize the mobile viewport and preserve random-access memory (RAM) capacity. This balance is struck by directing the user away from a main content hub of an application and loading a new page for focusing on user-selected content. However, this paradigm does not allow the user to multi-task and simultaneously interact with multiple content elements on the same viewport. This deficiency is most evident with mobile devices due to the limited size of their viewports but is also true on larger desktop views whereby the user is not able to multi-task within a single window.

Despite the fact that certain versions of list view or static grid views are intended to optimize screen space on viewports with limited space, these views are cumbersome in their interaction with the user. For example, a list view limits the viewing of content in a single direction or axis, usually either vertical or horizontal. This has the effect of ordering content based on a single parameter such as time (oldest to newest or newest to oldest), a relevance score, etc. As such, content is served to the client in a non-dynamic manner and does not optimize the viewport between displayed content that is of more interest to the user from content of less interest to the user. Moreover, interactive functions of each of the displayed content are usually provided within the list, thereby taking up space on the viewport from other content that could have been displayed.

A static grid view has similar limitations as the list view with the exception that content is displayed across both a horizontal and a vertical axis of the viewport. While content is organized across two dimensions in a static grid view, similar limitations are evident with respect to the non-dynamic manner of the displayed content. In addition, a user has to usually be directed away from the static grid view to interact with the content of interest, thereby concealing other content of interest that could be displayed to the user or interacted with by the user. Even with intuitive algorithms, at any given moment, only a small fraction of content may be of interest to a given user and an even smaller fraction of content is available for interaction with the user. Accordingly, there is a need for an improved dynamic content grid that allows for the user to multi-task and simultaneously interact with multiple content elements on the same viewport.

### SUMMARY OF THE INVENTION

A computer program product, computer implemented method, and system are disclosed for providing a tool with which a user may use to multi-task and simultaneously interact with multiple content elements on the same viewport.

The embodiments disclosed provide a tool to optimize a viewport on a consumer electronic device. The tool allows for the user to multi-task and simultaneously interact with multiple content elements on the same viewport.

In one aspect, a computer program product is provided for optimizing a viewport on a consumer electronic device. The computer program product including a computer readable storage device having program code embodied therewith. The program code is executable by a processor to display a content grid on the viewport of the consumer electronic device. The content grid includes an array of media elements. In response to a user selecting a first media element of the array of media elements, the program code is executable by a processor to expand the size of the selected first media element to become an expanded first media element and reconfigure the displayed content grid to accommodate the expanded first media element.

In another aspect, a method is provided for optimizing a viewport on a consumer electronic device. A content grid is displayed on the viewport of the consumer electronic device. In response to a user selecting a first media element of the array of media elements, the size of the selected first media element is expanded to become an expanded first media element and the displayed content grid is reconfigured to accommodate the expanded first media element.

In yet another aspect, a system is provided for optimizing a viewport on a consumer electronic device. The system includes a consumer-side tool in communication with a first processor, a viewport, and operatively coupled to a first memory. The system further includes a server-based tool in network communication with the consumer-side tool and a database. The server-based tool is configured to send media elements to the consumer-side tool. Upon receipt of the media elements, the consumer-side tool is configured to display a content grid on the viewport. The content grid includes an array of the media elements received from the server-based tool. In response to a user selecting a first media element of the array of media elements, the consumer-side tool is configured to expand the size of the selected first media element to become an expanded first media element and reconfigure the displayed content grid to accommodate the expanded first media element.

These and other features and advantages will become apparent from the following detailed description of the presently preferred embodiment(s), taken in conjunction with the accompanying drawings.

### BRIEF DESCRIPTION OF THE DRAWINGS

The drawings reference herein forms a part of the specification. Features shown in the drawings are meant as illustrative of only some embodiments, and not of all embodiments unless otherwise explicitly indicated.

FIG. 1 depicts a viewport of a consumer electronic device with a content grid, in accordance with an embodiment.

FIG. 2 depicts a viewport of a consumer electronic device with a content grid, in accordance with an embodiment.

FIG. 3 depicts a viewport of a consumer electronic device with a content grid, in accordance with an embodiment.

FIG. 4 depicts a viewport of a consumer electronic device with a content grid, in accordance with an embodiment.

FIG. 5 depicts a viewport of a consumer electronic device with a content grid having two expanded media elements, in accordance with an embodiment.

FIG. 6 depicts a viewport of a consumer electronic device with a content grid having two expanded media elements, in accordance with an embodiment.

FIG. 7 depicts a viewport of a consumer electronic device with a content grid having two expanded media elements, in accordance with an embodiment.

FIG. 8 depicts a viewport of a consumer electronic device with a fully expanded media element.

FIG. 9 depicts a viewport of a consumer electronic device with a fully expanded comment section corresponding to a fully expanded media element.

FIG. 10 depicts a viewport of a consumer electronic device with a content grid.

FIG. 11 depicts a viewport of a consumer electronic device displaying a size comparison of a collapsed media element and an expanded media element.

FIG. 12 depicts three viewports of a consumer electronic device in side-by-side comparison with each viewport displaying an expanded medium media element, a content view of an expanded small media element, and a text view of an expanded small media element, respectively.

FIG. 13 depicts a viewport of a consumer electronic device displaying an administrator view of a media interaction window and a standard view of a media interaction window.

FIG. 14 depicts a procedure to be performed by the consumer electronic device in accordance with an embodiment.

FIG. 15 depicts a bin packing algorithm configured to optimize the content grid in accordance with an embodiment.

FIG. 16 depicts an alternative bin packing algorithm configured to optimize the content grid in accordance with an embodiment.

FIG. 17 depicts an example page of a content grid in accordance with an embodiment.

FIG. 18 depicts a block diagram showing components of a system, in accordance with an embodiment, for optimizing a viewport on a consumer electronic device.

### DETAILED DESCRIPTION OF EMBODIMENTS OF THE INVENTION

It will be readily understood that the components of the present embodiment(s), as generally described and illustrated in the Figures herein, may be arranged and designed in a wide variety of different configurations. Thus, the following detailed description of the embodiments of the apparatus, system, and method of the present embodiment(s), as presented in the Figures, is not intended to limit the scope of the embodiment(s), as claimed, but is merely representative of selected embodiments.

Tools, as referred to herein, may be implemented in programmable hardware devices such as field programmable gate arrays, programmable array logic, programmable logic devices, or the like. Tools may also be implemented in software for execution by various types of processors. An identified tool, as executable code may, for instance, comprise one or more physical or logical blocks of computer instructions which may, for instance, be organized as an object, procedure, function, or other construct. Nevertheless, the executable of an identified tool need not be physically located together but may comprise disparate instructions stored in different locations which, when joined logically together, comprise the tool and achieve the stated purpose of the tool.

Furthermore, the described features, structures, or characteristics may be combined in any suitable manner in one or more embodiments. In the following description, numerous specific details are provided, such as examples of modules, managers, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “a select embodiment,” “one embodiment,” or “an embodiment” means that a particular feature, structure, or characteristic described in connection with the embodiment is included in at least one embodiment described herein. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiment(s) as claimed herein.

Indeed, executable code could be a single instruction, or many instructions, and may even be distributed over several different code segments, among different applications, and across several memory devices. Similarly, operational data may be identified and illustrated herein within the tool, and may be embodied in any suitable form and organized within any suitable type of data structure. The operational data may be collected as a single data set, or may be distributed over different locations including over different storage devices, and may exist, at least partially, as electronic signals on a system or network.

A computer program product is provided for optimizing a viewport on a consumer electronic device. The computer program product includes a computer readable storage device having program code embodied therewith. The program code is executable by a processor to display a content grid on the viewport of the consumer electronic device. A consumer electronic device may be a smartphone, an electronic tablet, or any other computational device with a screen as a viewport. The viewport of the consumer electronic device may take different shapes and dimensions. Accordingly, optimization of the viewport will be tailored to the particular size and shape of the viewport of the given consumer electronic device.

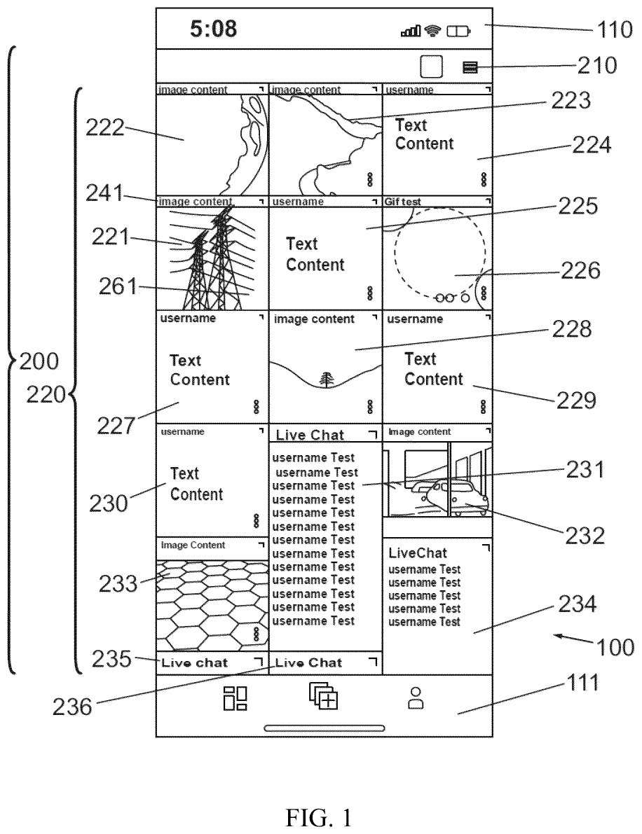

FIG. 1 depicts a viewport 100 of a consumer electronic device displaying a content grid 200. Specifically, the viewport 100 displays a status bar 110 on an upper portion of the viewport 100 and a menu bar 111 at a lower portion of the viewport 100. The status bar 110 provides information to the user with respect to the status of various components in the consumer electronic device such as time, remaining battery charge, Wi-Fi connectivity strength, and cellular signal strength. The menu bar 111 provides functionality to the user to navigate around the operating system of the consumer electronic device, and more specifically, functionality to navigate into and out of applications being run by the consumer electronic device. The remainder 200 of the viewport 100 is reserved for the open application being run by the consumer electronic device. Of the viewport remainder 200, the application being run may include an application menu bar 210 providing the user with necessary functionality to navigate aspects of the application and a content grid 220 including an array of media elements 221-236. The media elements 221-236 may each include a title and an interaction button. For example, the first media element 221 includes a title 241 and an interactive button 261. The functionality of the interactive button 261 will be described in further detail below.

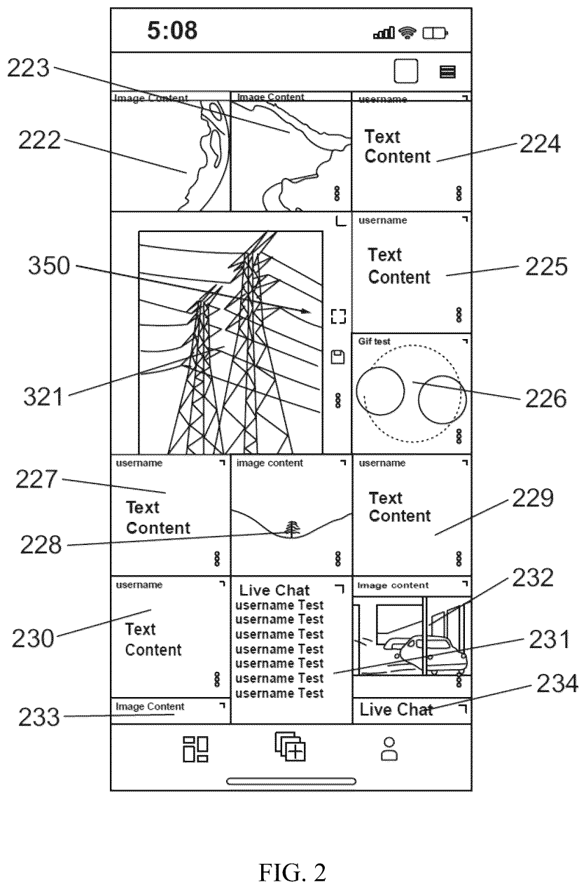

In response to a user selecting a media element, such as the first media element 221 of the array of media elements in the content grid 220, the program code is executable by a processor to expand the size of the selected first media element 221 to become an expanded first media element 321 and reconfigure the displayed content grid 220 to accommodate the expanded first media element 321. FIG. 2 depicts viewport 100 of the consumer electronic device displaying the content grid 200 accommodating the larger size of the expanded first media element 321. Because the size of the viewport 100 is fixed, a bin packing algorithm is performed to redistribute the remaining media elements 222-234 in an optimized manner. As shown in FIG. 2, media elements 235 and 236 are no longer displayed in viewport 100 and media elements 222-234 are repositioned to accommodate the expanded first media element 321.

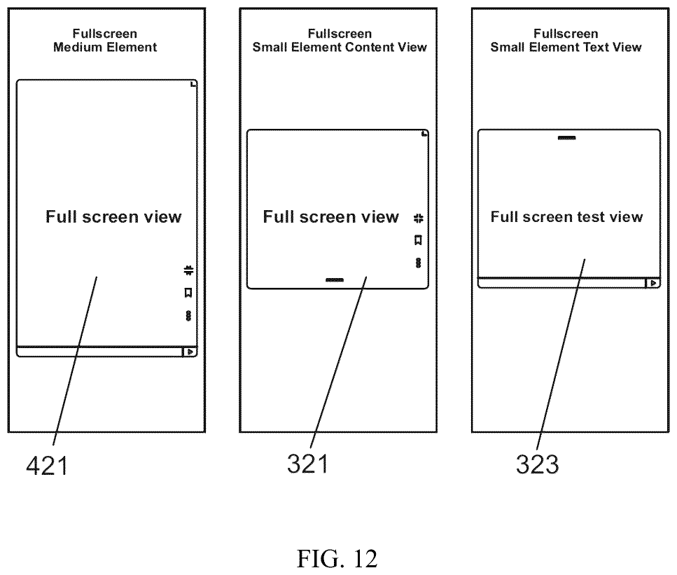

A bin packing algorithm is an optimization problem algorithm that seeks to fit objects of differing size within a fixed size area. In bin packing, the input is a set of objects, each having a given size, and a bin size that is at least as big as any object size. The goal of the algorithm is to partition the objects into as few subsets as possible, such that the total size of the objects in each subset is at most the bin size. The optimization problem is to find the minimum number of bins possible, and the decision problem takes a positive integer, for example n, as additional input and asks whether the partition can be done with n number of bins. Application of the bin packing algorithm to the content grid 220 displayed on the viewport 100 is described in further detail with respect to FIG. 12 below.

In response to a new media content being uploaded to the consumer electronic device, the new media content is applied to a new media element to be fitted within the content grid 220. The new media element is fitted to the displayed content grid 220 based on results of the bin packing algorithm, which is performed again with respect to the new media element.

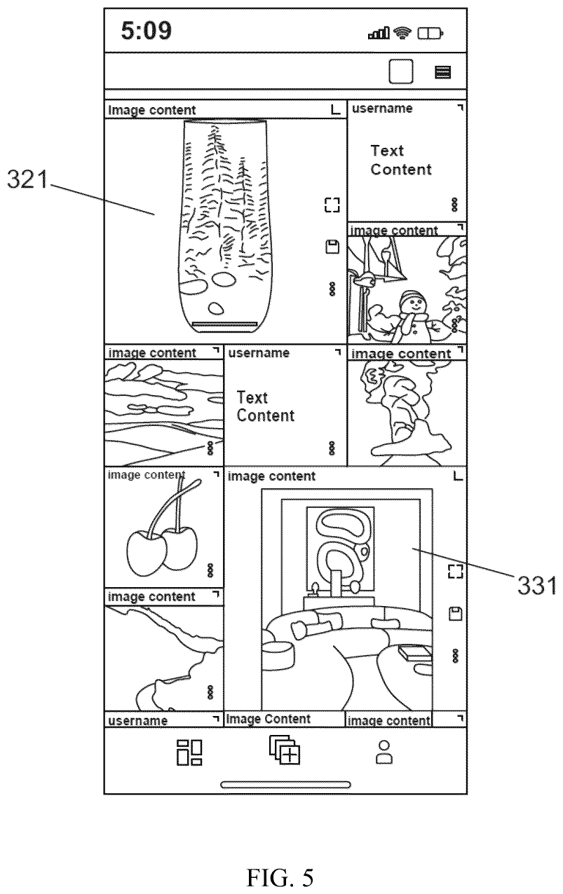

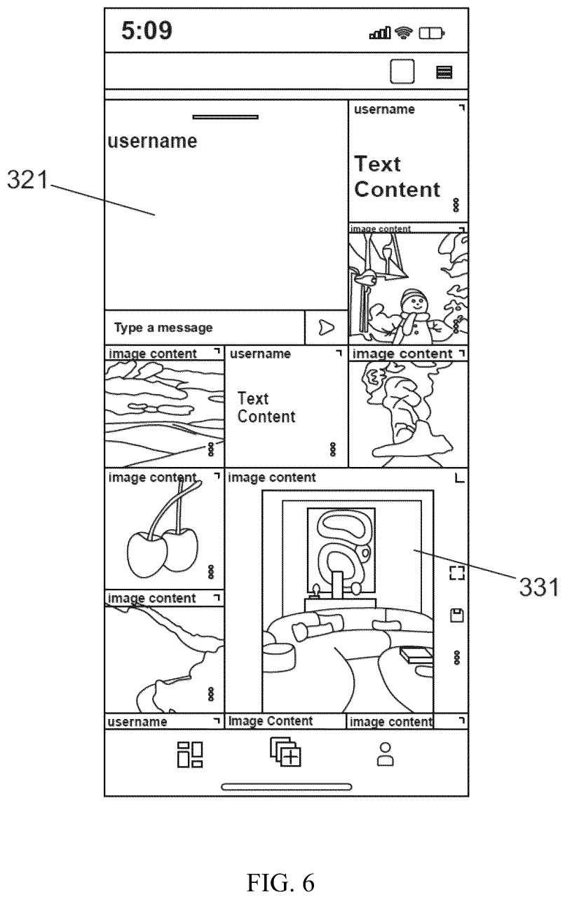

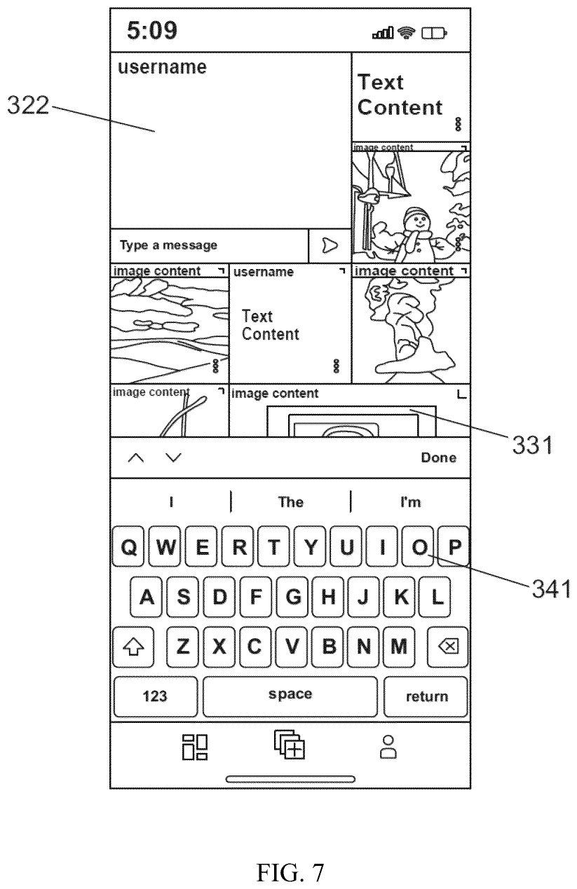

As shown in FIGS. 5-7, two media elements may be expanded at the same time. In response to the user selecting a second media element while the first media element is an expanded first element 321, the size of the selected second media element is expanded similarly to the expansion of the first media element 221 and becomes an expanded second media element 331. In addition, the displayed content grid 220 is reconfigured to accommodate the expanded first media element 321 and expanded second media element 331. In this mode, the expanded first media element 321 and expanded second media element 331 are simultaneously interactive with the user. As shown in FIG. 6, a user can interact with the expanded first media element 321 by tapping or swiping upwards on a bottom edge of the expanded first media element 321 to replace it with a first media interaction window 322 of equal size and location as the expanded first media element 321. In the example shown in FIG. 6, the first media interaction window 322 is a comment input window within which a user may type a comment in relation to the expanded first media element 321. As shown in FIG. 7, the operating system of the consumer electronic device may provide a keyboard 341 for the user to type with and insert text into the comment input window of the first media interaction window 322.

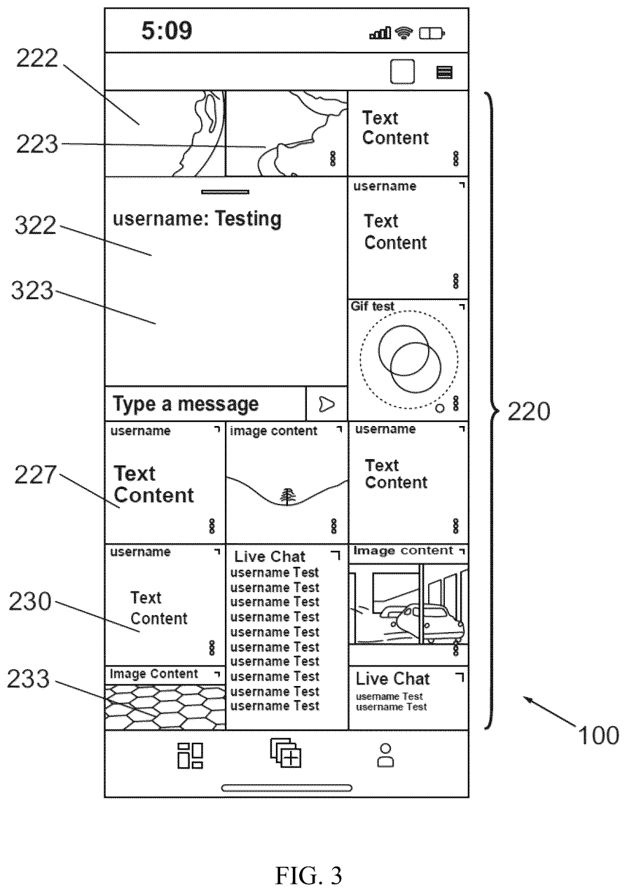

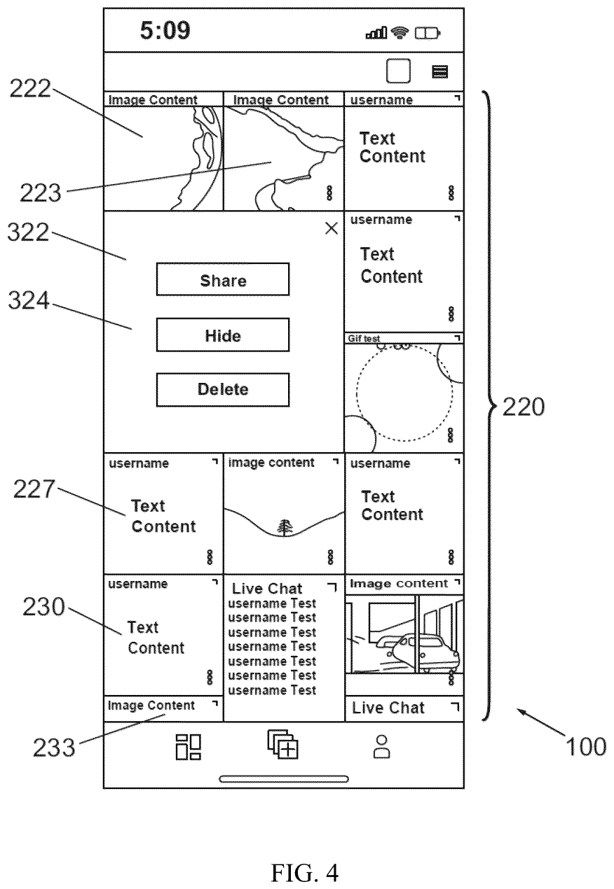

As shown in FIGS. 3 and 4, in response to the user tapping or swiping upwards on a bottom edge of the expanded first media element 321, the expanded first media element 321 is replaced with a first media interaction window 322 of equal size and location as the expanded first media element 321. Note, however, that if the computer program product is being executed on a desktop device, interactive functions available to the user may be to use a click method, scroll method, or a key and scroll combination method to allow the user to scroll within a media element without scrolling through the entire content grid. Any scroll functions in a desktop device scenario would not be dependent on user interaction with the bottom edge of the expanded first media element 321. The first media interaction window 322 may be a comment input window 323. In the comment input window 323, the user can type and submit a comment corresponding to the first media element. In response to the user tapping a button on the interaction ribbon 350, an administrative window 324 may appear providing the user a selection to hide, delete, share, edit, or report the first media element. A user with an administrative account related to the application may have a different selection of administrative buttons in the administrative window 324 than a user with a standard account related to the application. For example, while a user with a standard account may have a selection to ‘share’ the first media element with another user, a user with an administrative account may have a selection to ‘delete’ the first media element.

In response to the user tapping on the expanded first media element 321, or otherwise interacting with the expanded first media element 321 in a desktop scenario, the size of the expanded first media element 321 is collapsed to become the original size first media element 221, and the displayed content grid is reconfigured to fill a void caused by the collapsed first media element 221 using the bin packing algorithm. Similarly, in response to the user tapping or swiping on the expanded second media element, the size of the expanded second media element is collapsed to become the original size second media element, e.g. media element 229, and the displayed content grid is reconfigured to fill a void caused by the collapsed second media element using the bin packing algorithm.

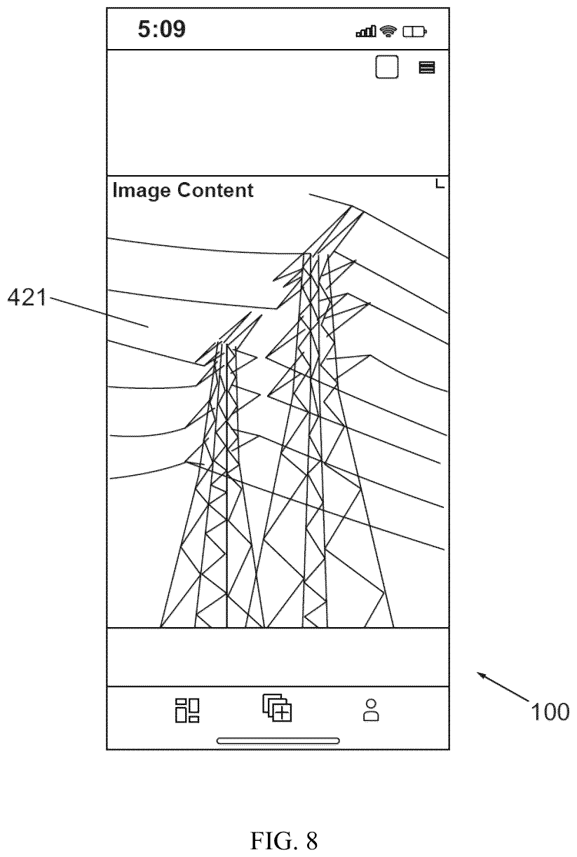

As shown in FIG. 8, an expanded media element may be further expanded to become a focused media element 421 when the user selects a button on an interaction ribbon 350 located within the expanded first media element 321. When the focused media element 421 is open, the content grid 220 is hidden behind the focused media element 421 and any portion of the content grid 220 that is not covered by the focused media element 421 is blurred to keep the user's focus on the information displayed on the focused media element 421.

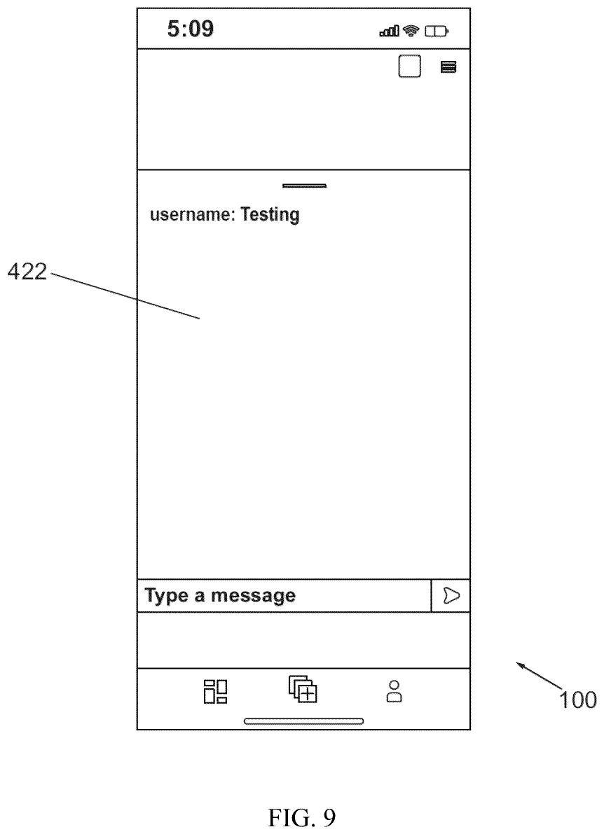

As shown in FIG. 9, in response to the user tapping or swiping upwards on a bottom edge of the focused media element 421, or otherwise interacting with the focused media element 421 in a desktop scenario, the focused media element 421 is replaced with a focused comment input window 422 of equal size and location as the focused media element 421. The comment input window allows the user to type and submit a comment corresponding to the first media element.

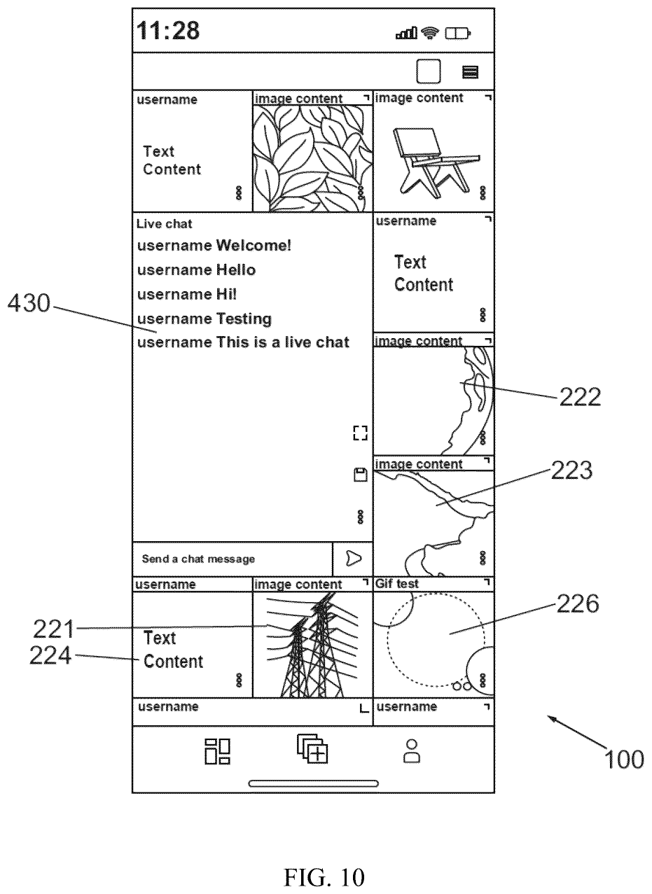

Not all media elements in the content grid 220 are of the same size. In addition, some elements may expand in a more horizontal or vertical fashion based on the aspect ratio of the content. For example, as shown in FIG. 10, a media element such as a live chat window 430 may have a different size and/or shape in the content grid 220 in comparison to the expanded first media element 321. Other media elements, e.g., 221-224, 226, are repositioned along the content grid 220 taking the size and shape of the live chat window 430 into account. The repositioning of the other media elements is done using the bin packing algorithm. Moreover, new media elements may be added to the content grid in a pre-expanded form to provide visual variety or highlight content based on parameters such as whether the new media element is sponsored content.

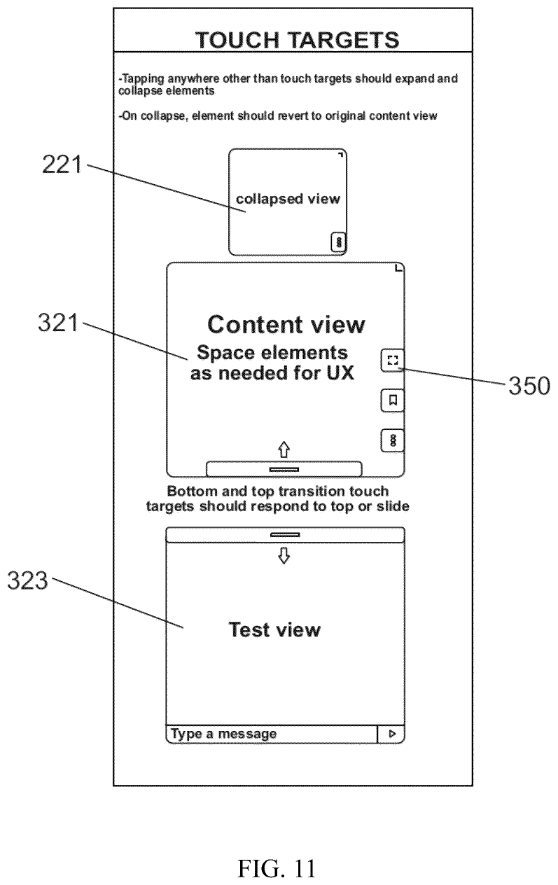

As shown in FIG. 11, tapping anywhere on the viewport 100 other than a touch target, such as a button on the interaction ribbon 350 located within the expanded first media element 321 expands or collapses media elements. A first media element 221 may be expanded to become an expanded first media element 321 and an expanded first media element 321 may be collapsed to become a first media element 221. The user may also swipe or slide an expanded first media element 321 to reveal the comment input window 323. As mentioned above, if the computer program product is being executed on a desktop device, interactive functions available to the user may be to use a click method, scroll method, or a key and scroll combination method to allow the user to scroll within a media element without scrolling through the entire content grid. Such scroll functions in a desktop device scenario would not be dependent on user interaction with the bottom edge of the expanded first media element 321.

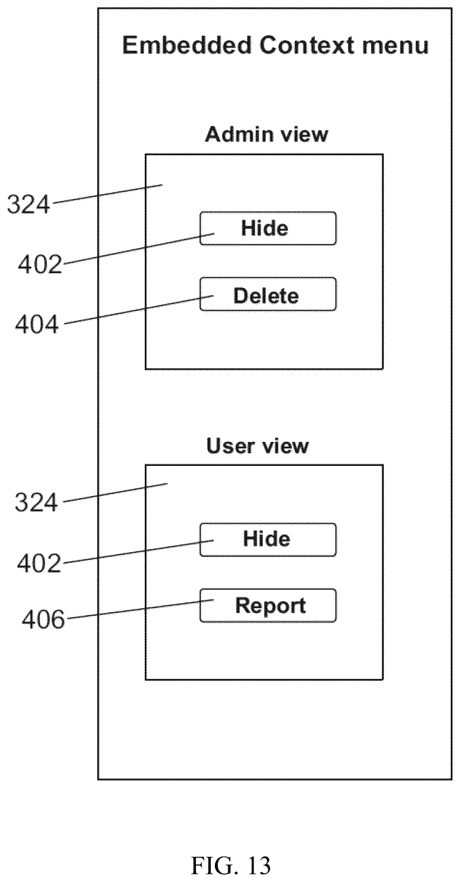

FIG. 12 depicts a size comparison between the focused media element 421, the expanded first media element 321 and the comment input window 323. FIG. 13 depicts a comparison of the functionality of the administrative window 324 when the user has either an administrative account or a standard account. For example, with an administrative account, a user can select to ‘hide’ or ‘delete’ the first media element. The ‘hide’ function 402 allows a user to ‘hide’ an element from their content grid 220. The ‘delete’ function 404 allows a user to ‘delete’ an element from the software application completely. With a standard account, the user can select to ‘hide’ or ‘report’ the first media element. With a standard account, the administrative window may include the ‘hide’ 402 or ‘report’ 406 function available to allow the user to ‘hide’ an element from their content grid or ‘report’ the element to an administrator. Upon receiving a report from a user with a standard account, a user with an administrative account may choose to delete the element entirely.

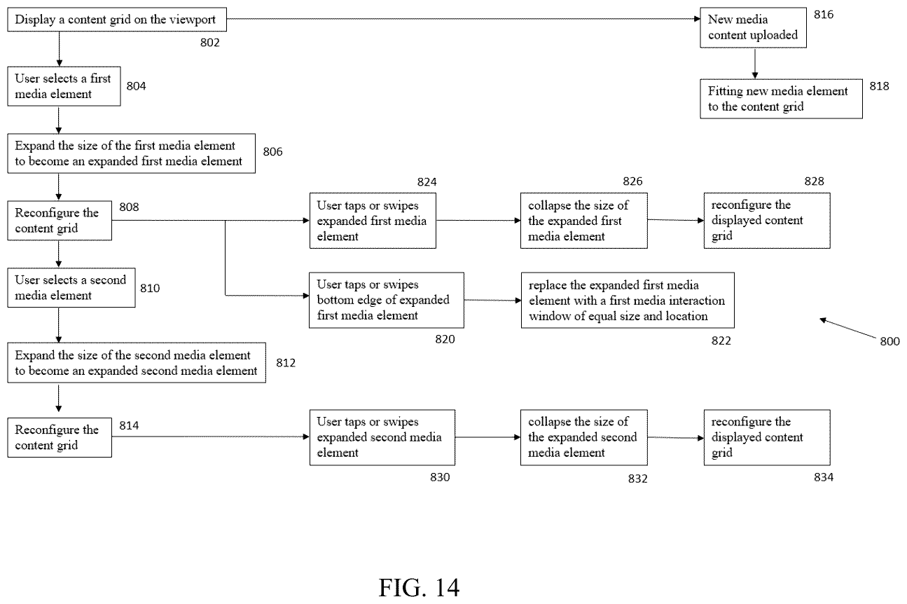

With respect to FIG. 14, a method 800 is provided for optimizing a viewport on a consumer electronic device. The method 800 includes displaying a content grid on the viewport of the consumer electronic device (802). The content grid includes an array of media elements. The array of media elements may be randomized or may be organized on the content grid, for example, by chronological order or any other pre-determined algorithmic feed. In response to a user selecting a first media element of the array of media elements (804), the method 800 includes expanding the size of the selected first media element to become an expanded first media element (806) and reconfiguring the displayed content grid to accommodate the expanded first media element (808). The reconfiguration of the displayed content grid is performed based on results of a bin packing algorithm.

In response to the user selecting a second media element while the first media element is expanded (810), the method 800 includes expanding the size of the selected second media element to become an expanded second media element (812) and reconfiguring the displayed content grid to accommodate the expanded first media element and expanded second media element (814). The expanded first media element and the expanded second media element remain simultaneously interactive with the user. There is no maximum to the number of media elements that are simultaneously expanded. However, due to the finite size and pixel density of the viewport, the maximum number of media elements that are simultaneously expanded may be limited to a predetermined number for viewing practicality.

In response to new media content being uploaded to the consumer electronic device (816), a new media element is formed and fitted to the displayed content grid based on results of the bin packing algorithm (818). The new media element that is formed corresponds to the uploaded new media content.

In response to the user tapping or swiping upwards on a bottom edge of an expanded first media element (820), or otherwise interacting with the expanded first media element in a desktop scenario, the method 800 includes replacing the expanded first media element with a first media interaction window of equal size and location as the expanded first media element (822). The first media interaction window may be a comment input window where the user may type comments regarding the media content corresponding to the first media element. Alternatively, the first media interaction window may be an administrative window allowing the user to either hide, delete, or report the first media element.

In response to the user tapping on the expanded first media element (824), or otherwise interacting with the expanded first media element in a desktop scenario, the method 800 includes collapsing the size of the expanded first media element (826) and reconfiguring the displayed content grid to fill a void caused by the collapsed first media element using a bin packing algorithm (828). Tapping or swiping by the user on the expanded second media element (830) would result in collapsing the size of the expanded second media element (832) and reconfiguring the displayed content grid to fill a void caused by the collapsed second media element using the bin packing algorithm (834).

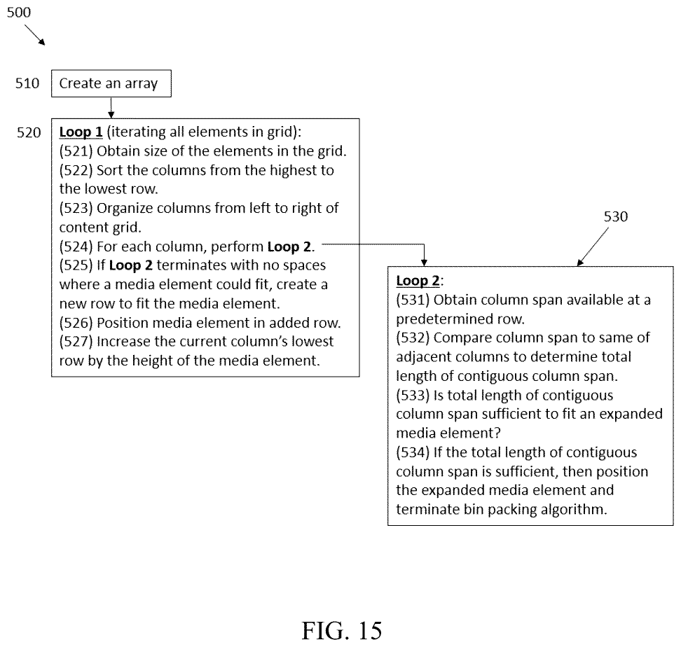

FIG. 15 depicts a bin packing algorithm 500 configured to optimize positioning and sizing of the array of media elements on the content grid displayed on the viewport of a consumer electronic device. The bin packing algorithm 500 begins by creating an array (510) logging the positioning of each media element in the content grid. The array is configured to keep track of the bottom row of media elements in the content grid. Keeping track with an array enables determining whether there is room to add an additional media element to one or more of the columns.

The bin packing algorithm 500 continues with a first loop 520, which is configured to iterate media elements in the content grid. The first loop 520 begins with obtaining the size of each element in the grid (521). The size of each element may be determined to be one of three sizes. The columns of media elements are then sorted depending on their height (522) taking into account the stacking of media elements within the corresponding columns. The space for elements that span multiple columns may be determined by the identification of multi-column space for expanded media elements. The columns that, when combined, are determined to form multi-column space for expanded media elements are then grouped together by repositioning these columns to be organized from left to right or right to left in the content grid such that the columns either increase or decrease in height based on the stacking of media elements within them (523).

As a next step in the first loop 520, for each individual column within the content grid, a second loop 530 is performed (524). The second loop 530 begins with obtaining a column span for a predetermined row in the column for which the second loop 530 is being performed (531). Compare the column span of the current column to the column span of adjacent columns to determine a total length of contiguous column span (532). Determine whether the total length of contiguous column span is sufficient to fit an expanded media element (533). If the total length of contiguous column span is sufficient to fit an expanded media element, then position the expanded media element in the contiguous column span (534) and end the bin packing algorithm 500. If the total length of contiguous column span is not sufficient to fit an expanded element, then repeat the second loop 530 for a subsequent column.

Once the second loop 530 has ended for each column, and if second loop 530 ended with no spaces available for the expanded media element, the bin packing algorithm 500 proceeds in the first loop 520 by creating an additional row across all the columns of the content grid to fit the expanded media element (525). The expanded media element is then positioned in the additional row (526) and the height of the column with the expanded media element is increased by the height of the expanded media element (527).

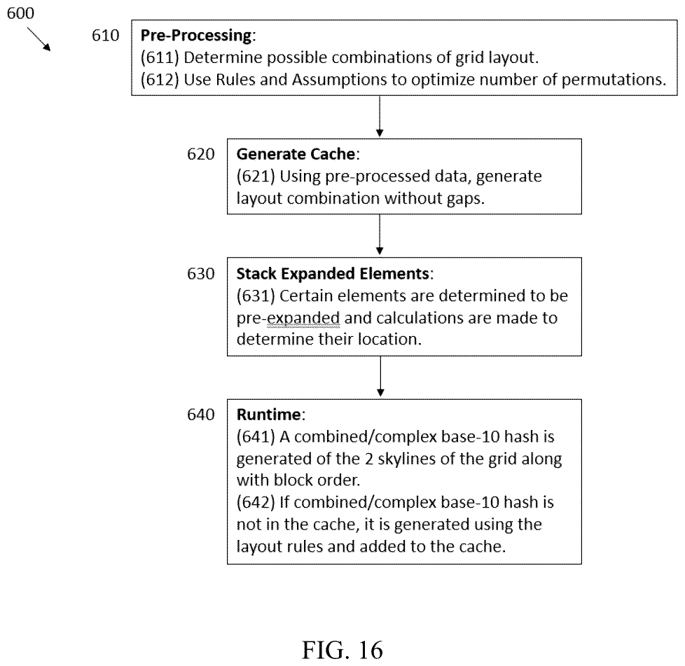

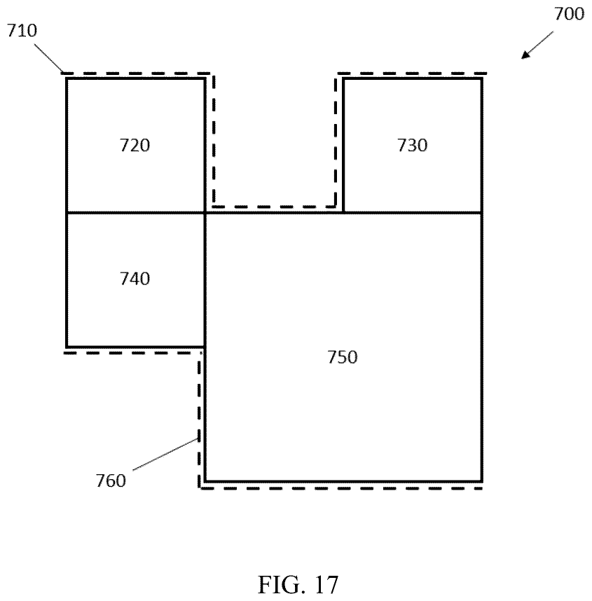

FIG. 16 depicts an alternative bin packing algorithm 600 configured to optimize positioning and sizing of the array of media elements on the content grid displayed on the viewport of a consumer electronic device. The bin packing algorithm 600 begins with a pre-processing stage 610 that includes first determining possible combinations, or permutations, of the array of media elements and their positioning on a content grid (611). The content grid is comprised of ‘pages’ in the same manner as that of a conventional list view or infinite scroll view. As shown in the example depicted in FIG. 17, each of the pages 700 in a content grid consists of a top skyline 710, formed of the border at the top edges of the topmost elements (elements 720, 750 and 730) in each page, and a bottom skyline 760, formed of the border at the bottom edges of the bottommost elements (elements 740 and 750) in each page 700. The bin packing algorithm 600 is to account for both the order and configuration of elements within each page, as well as the “fitting” together of bottom and top skylines, respectively, of consecutive pages.

“Rules” and “Assumptions” are used to filter the number of permutations to an optimized number (612). A “rule” may include limitations such as a required number of elements on a page, a maximum number of expanded elements per page, or a requirement to contract an expanded element when a certain number of pre-expanded elements are on a single side (so as to prevent pre-expanded elements from all opening on a single side of the grid). An “assumption” is a statistical basis upon which the bin packing algorithm 600 is run, such as an assumption that there will be more images than videos uploaded on a content grid, or that there will be less live chats than images uploaded on a content grid.

For example, to determine how pages of a content grid are stitched together, a layout is requested as a combination of three hashes: HASH 1, HASH 2, and HASH 3. HASH 1 determines that a top skyline is a 3-digit value with ranges of 0-2, 0-2, and 0-2, respectively. HASH 2 determines that a bottom skyline is a long string of box sizes. HASH 3 determines page configuration, which includes the type of block size, expanded state of the block, and position of the block. To build a cache of layouts, all permutations of pages are generated, thereby resulting in a 21-digit base-6 number. Each digit is one of seven element sizes (variations of expanded size). In this example, the 21-digit base-6 number is 240231654354064504324 and results in 39,070,080 possible permutations. Applying ‘rules’ to the content grid filters out many permutations, resulting in, for example, ˜143640+78 (base-4 collapsed plus 3-digit base 3 expanded in 3 possible positions). Considering the vast number of possible skylines of the permutations, the number of skylines may also be filtered using rules and assumptions. Using assumptions such as that there will be more images than videos uploaded on a content grid and that there will be less live chats than images uploaded on a content grid, a total number of skyline permutations may be decreased to ˜7980+78 in this example. This number may be further decreased with additional assumptions such as that that there will be a disproportionate amount of 1×1 sized elements.

The bin packing algorithm 600 continues with a cache generation stage 620 whereby using pre-processed data, a layout combination is generated without gaps (621). Such generation may require multiple iterations to result in a visually appealing layout cache. Each iteration also may result in an adjustment of “assumption” weights until gaps are minimized.

At an expanded elements stacking stage 630, for each element, a calculation is made according to the grid line number to determine whether the element will be positioned on the left or right of the content grid. This is required as every grid recalculation in the event of a cache miss would result in randomly selecting a new position and cause too much movement otherwise.

At the runtime stage 640 of the bin packing algorithm 600, a combined/complex base-10 hash is generated of the 2 skylines of the grid along with block order (641). If the combined/complex base-10 hash is not in the cache, it is generated using the layout rules and added to the cache (642). Performing these steps prevents content grid actions such as rapidly expanding or rapidly contracting elements from causing excessive recalculations. In this stage, pages are stitched together along the respective top and bottom skylines in a puzzle piece manner.

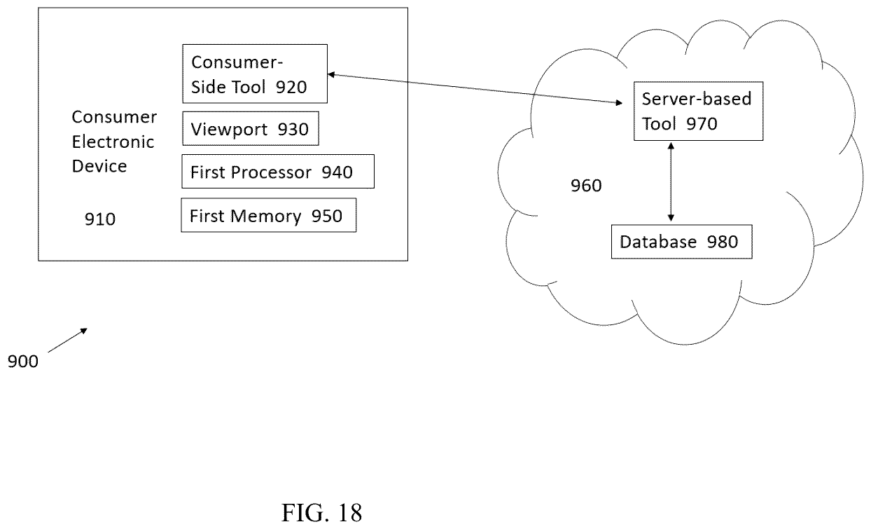

With respect to FIG. 18, a system 900 includes a consumer electronic device 910 in communication with a server-based tool 970. The server-based tool 970 may be in wireless or direct communication with the consumer electronic device 910 and may be provided on a cloud-based platform 960. The consumer electronic device 910 includes a consumer-side tool 920 configured to communicate with the server-based tool 970. The consumer-side tool is in communication with a first processor 940, a viewport 930, and is operatively coupled to a first memory 950. The server-based tool 970 is in network communication with the consumer-side tool 920 and a database 980. The database 980 may also be cloud-based 960.

The server-based tool 970 is configured to send media elements to the consumer-side tool 920. Upon receipt of the media elements from the server-based tool 970, the consumer-side tool 920 is configured to display a content grid on the viewport 930. The content grid includes an array of the media elements received from the server-based tool 970. In response to a user selecting a first media element of the array of media elements, the consumer-side tool 920 is configured to expand the size of the selected first media element, thereby making the first media element an expanded first media element. In addition, the consumer-side tool 920 is configured to reconfigure the displayed content grid to accommodate the expanded first media element. Specifically, the reconfiguration of the displayed content grid is performed by the consumer-side tool 920 or the first processor 940 of the consumer electronic device 910 based on results of a bin packing algorithm.

The server-based tool 970 may send new media content to the consumer-side tool. The consumer-side tool 920 is configured to upload the new media content, perform the bin packing algorithm with respect to the new media content, and fit a new media element to the displayed content grid based on results of the bin packing algorithm. The new media element would correspond to the uploaded new media content. The computation of the bin packing algorithm with respect to the new media content may be performed by the first processor 940.

If the user were to select a second media element while the first media element is expanded, the consumer-side tool 920 is configured to expand the size of the selected second media element to become an expanded second media element and reconfigure the displayed content grid to accommodate both the expanded first media element and expanded second media element. The reconfiguration of the displayed content grid in this instance may also be done by using the bin packing algorithm. In addition, the expanded first media element and the expanded second media element are simultaneously interactive with the user. For example, a video may be played in one media element while the user types a message or comment on another media element.

In response to the user tapping or swiping upwards on a bottom edge of the expanded first or second media element, or otherwise interacting with the expanded first media element in a desktop scenario, the consumer-side tool is configured to replace the expanded media element with a media interaction window of equal size and location as the expanded media element. The media interaction window includes a comment input window or an administrative window allowing the user to either ‘hide,’ ‘delete,’ or ‘report’ the media element. These functions may be available depending on they type of profile the user has with the associated account of the tool. For example, if the user has an administrator account, the administrative window may include the ‘hide’ or ‘delete’ function available to allow them to ‘hide’ an element from their content grid or ‘delete’ an element from the database 980 entirely. Alternatively, if the user has a standard account, the administrative window may include the ‘hide’ or ‘report’ function available to allow them to ‘hide’ an element from their content grid or ‘report’ the element to an administrator.

The present embodiment(s) may be a system, a method, and/or a computer program product. The computer program product may include a computer readable storage medium (or media) having computer readable program instructions thereon for causing a processor to carry out aspects of the present embodiment(s).

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Accordingly, a computer readable storage medium, as used herein, is non-transitory.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiment(s) may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiment(s).

Aspects of the present embodiment(s) are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to the various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present embodiment(s) has been presented for purposes of illustration and description but is not intended to be exhaustive or limited to the embodiment(s) in the form disclosed. Many modifications and variations will be apparent to those of ordinary skill in the art without departing from the scope and spirit of the embodiment(s). The embodiment was chosen and described in order to best explain the principles and the practical application, and to enable others of ordinary skill in the art to understand the embodiment(s) for various embodiments with various modifications as are suited to the particular use contemplated.

It will be appreciated that, although specific embodiments have been described herein for purposes of illustration, various modifications may be made without departing from the spirit and scope of the invention. In particular, different metrics, hardware components, and virtual components may be used. Accordingly, the scope of protection of this invention is limited only by the following claims and their equivalents.

What is claimed is:

1. A computer program product for optimizing a viewport on a consumer electronic device, the computer program product comprising a computer readable storage device having program code embodied therewith, the program code executable by a processor to:
display a content grid on the viewport of the consumer electronic device, the content grid including an array of media elements; and
in response to a user selecting a first media element of the array of media elements,
expand the size of the selected first media element to become an expanded first media element, and
reconfigure the displayed content grid to accommodate the expanded first media element.

2. The computer program product of claim 1, wherein the reconfiguration of the displayed content grid is performed based on results of a bin packing algorithm.

3. The computer program product of claim 1, further comprising program code executable by a processor to:
in response to a new media content being uploaded to the consumer electronic device, fit a new media element to the displayed content grid based on results of a bin packing algorithm, the new media element corresponding to the uploaded new media content.

4. The computer program product of claim 2, further comprising program code executable by a processor to:
in response to the user selecting a second media element while the first media element is expanded,
expand the size of the selected second media element to become an expanded second media element, and
reconfigure the displayed content grid to accommodate the expanded first media element and expanded second media element.

5. The computer program product of claim 4, wherein the expanded first media element and the expanded second media element are simultaneously interactive with the user.

6. The computer program product of claim 1, further comprising program code executable by a processor to:
in response to the user tapping, clicking, or swiping upwards on a bottom edge of the expanded first media element,
replace the expanded first media element with a first media interaction window of equal size and location as the expanded first media element, wherein the first media interaction window is a comment input window.

7. The computer program product of claim 4, further comprising program code executable by a processor to:
in response to the user tapping or clicking on the expanded first media element, collapse the size of the expanded first media element, and reconfigure the displayed content grid to fill a void caused by the collapsed first media element using a bin packing algorithm; and
in response to the user tapping or clicking on the expanded second media element, collapse the size of the expanded second media element, and reconfigure the displayed content grid to fill a void caused by the collapsed second media element using the bin packing algorithm.

8. A method for optimizing a viewport on a consumer electronic device, the method comprising:
displaying a content grid on the viewport of the consumer electronic device, the content grid including an array of media elements;
in response to a user selecting a first media element of the array of media elements,
expanding the size of the selected first media element to become an expanded first media element, and
reconfiguring the displayed content grid to accommodate the expanded first media element.

9. The method of claim 8, wherein the reconfiguration of the displayed content grid is performed based on results of a bin packing algorithm.

10. The method of claim 8, further comprising:
in response to a new media content being uploaded to the consumer electronic device, fitting a new media element to the displayed content grid based on results of a bin packing algorithm, the new media element corresponding to the uploaded new media content.

11. The method of claim 9, further comprising:
in response to the user selecting a second media element while the first media element is expanded,
expanding the size of the selected second media element to become an expanded second media element, and
reconfiguring the displayed content grid to accommodate the expanded first media element and expanded second media element.

12. The method of claim 11, wherein the expanded first media element and the expanded second media element are simultaneously interactive with the user.

13. The method of claim 8, further comprising:
in response to the user tapping, clicking, or swiping upwards on a bottom edge of the expanded first media element,
replacing the expanded first media element with a first media interaction window of equal size and location as the expanded first media element, wherein the first media interaction window comprises of:
a comment input window, or
an administrative window allowing the user to either hide, delete, or report the first media element.

14. The method of claim 11, further comprising:
in response to the user tapping, clicking, or swiping on the expanded first media element,
collapsing the size of the expanded first media element, and
reconfiguring the displayed content grid to fill a void caused by the collapsed first media element using a bin packing algorithm; and
in response to the user tapping, clicking, or swiping on the expanded second media element,
collapsing the size of the expanded second media element, and
reconfiguring the displayed content grid to fill a void caused by the collapsed second media element using the bin packing algorithm.

15. A system comprising:
a consumer-side tool, the consumer-side tool in communication with a first processor, a viewport, and operatively coupled to a first memory;
a server-based tool in network communication with the consumer-side tool and a database, the server-based tool to:
send media elements to the consumer-side tool;
wherein upon receipt of the media elements, the consumer-side tool is configured to:
display a content grid on the viewport, the content grid including an array of the media elements received from the server-based tool; and
in response to a user selecting a first media element of the array of media elements,
expand the size of the selected first media element to become an expanded first media element, and
reconfigure the displayed content grid to accommodate the expanded first media element.

16. The system of claim 15, wherein the reconfiguration of the displayed content grid is performed by the consumer-side tool based on results of a bin packing algorithm.

17. The system of claim 15, wherein:
the server-based tool is configured to send new media content to the consumer-side tool, and
the consumer-side tool is configured to:
upload the new media content,
perform a bin packing algorithm, and
fit a new media element to the displayed content grid based on results of the bin packing algorithm, the new media element corresponding to the uploaded new media content.

18. The system of claim 16, wherein in response to the user selecting a second media element while the first media element is expanded, the consumer-side tool is configured to:
expand the size of the selected second media element to become an expanded second media element, and
reconfigure the displayed content grid to accommodate the expanded first media element and expanded second media element.

19. The system of claim 18, wherein the expanded first media element and the expanded second media element are simultaneously interactive with the user.

20. The system of claim 15, wherein in response to the user interacting with the expanded first media element, the consumer-side tool is configured to:
replace the expanded first media element with a first media interaction window of equal size and location as the expanded first media element, the first media interaction window comprising:
a comment input window, or
an administrative window allowing the user to either hide, delete, or report the first media element.
